(19) United States
(12) Patent Application Publication
(10) Pub. No.: US 2013/0242265 A1
(43) Pub. Date: Sep. 19, 2013

(54) OPTICAL MODULE AND SCANNING IMAGE DISPLAY DEVICE

(71) Applicant: HITACHI MEDIA ELECTRONICS CO., LTD., Oshu-shi (JP)

(72) Inventors: Seiichi KATO, Tsuchiura (JP); Atsushi KAZAMA, Hitachinaka (JP); Yasuo AMANO, Yokohama (JP); Norio HOSAKA, Yokohama (JP); Tsutomu KUROIWA, Yokohama (JP); Teppei TANAKA, Yokohama (JP)

(73) Assignee: HITACHI MEDIA ELECTRONICS CO., LTD., Oshu-shi (JP)

(21) Appl. No.: 13/789,772

(22) Filed: Mar. 8, 2013

(30) Foreign Application Priority Data
Mar. 14, 2012 (JP) 2012-056614

(51) Int. Cl. G03B 21/16; F21V 29/00

(52) U.S. Cl. CPC G03B 21/16; F21V 29/00
USPC 353/31; 353/52; 362/249.01; 362/231

(57) ABSTRACT

In an optical module that aligns light beams from lasers of the three colors of red, green, and blue along a single combined beam optical axis, when the ambient temperature range is wider than the guaranteed operating range of the lasers, relative positional displacements of beam spots of the three colors that are generated due to a displacement or a deformation resulting from a temperature range at a heating time or a cooling time are suppressed. The optical module, which has mounted thereon a plurality of lasers, and emits light beams from the plurality of lasers, includes a cooling device that cools the entire optical module via a case on which the optical module is mounted, and heating devices that are provided on respective laser holders and individually heat the respective lasers.

### BACKGROUND

1. Technical Field

The present invention relates to an optical module and a scanning image display device. For example, the present invention relates to an optical module that emits light beams from a plurality of lasers so as to align the light beams along a single optical axis, and a scanning image display device that displays an image of the light beams from the optical module.

2. Background Art

In recent years, compact projectors that can be easily carried about and can display images on large screens have been actively developed. Compact projectors that can be connected to notebook PCs and the like and video cameras and the like having built-in projectors that can project recorded images are already available in the market. Thus, it is predicted that projectors built in portable phones or smart phones will also become available in future.

As a scheme of projectors, a scheme of using a lamp, an LED, or the like for a light source and projecting an image displayed with a liquid crystal panel or a digital micro mirror device (DMD) has been previously known. Further, a laser projector (a scanning image display device) that displays an image by using a laser for a light source and performing single light beam scanning using a movable mirror has also been developed. As a laser is used for the light source, focusing need not be performed and the luminance of an image can be easily increased. Thus, such a projector is considered to be suitable for an application in which an image is projected onto a wall that is available outside one's home.

It is also predicted that such a projector will be mounted on a vehicle or the like utilizing the high luminance of an image, and be applied to a head-up display so that an image is projected onto a front glass or a navigation image is displayed, for example.

For example, Patent Document 1 describes a scanning image display device capable of displaying a color image, the device being adapted to use lasers of the three colors of red, blue, and green, and including a beam coupling unit that couples laser beams of the three colors into a combined beam that travels along a single axis, and a beam scanner that performs scanning in the deflection direction of the combined beam. Patent Document 1 describes that, as the configuration of the beam coupling unit, the three light sources are arranged in parallel so that the beams are emitted in the same direction, and then the beams are reflected by corresponding respective beam coupling mirrors, so as to be coupled into a combined beam.

Conventionally, there has been no laser that directly emits a green light beam. Thus, Patent Document 1 describes obtaining a green light beam by converting the wavelength of an infrared light beam through SHG (second harmonic generation). However, in recent years, a laser that directly emits a green light beam has come to be available.
Patent Document 1: JP Patent Publication (Kohyo) No. 2009-533715 T
Patent Document 1: JP Patent Publication (Kokai) No. 2000-77580 A

### SUMMARY

In a scanning image display device such as the one described above, it is important that the optical axes of the light beams of the three colors be aligned with high accuracy and the operating temperature of the lasers be maintained. If the optical axes are misaligned, a problem would arise that relative positional displacements of spots of the respective colors are generated on a display region such as a screen, so that a resulting image becomes blurred.

Thus, when assembling a module, the module should be assembled by making adjustment so that the optical axes of the three colors are aligned. In addition, when using a scanning image display device, there is a problem in that it is necessary to take into consideration deviations of the optical axes due to a possible positional displacement of an optical component resulting from heat deformation.

Meanwhile, when the operating temperature of a laser is outside the guaranteed operating temperature range of the laser, a difference in the visibility of each color would be generated due to a temperature-dependent laser wavelength fluctuation, so that a color deviation of the image would occur such that the entire screen becomes reddish, or the laser output would decrease or the operating life of the laser would shorten. Thus, an optical module for a case where the ambient temperature range is wider than the guaranteed operating temperature range of lasers such as a head-up display mounted on a vehicle or the like has a problem in that heating and cooling devices are needed for adjusting the temperatures of the lasers to be within the guaranteed operating temperature range of the lasers.

As an electronic component device with heating and cooling devices for merely controlling the temperature of a semiconductor element, a temperature-controlled semiconductor device such as the one described in Patent Document 2 is known.

However, in the conventional art, the following problem with an optical module for a case where the ambient temperature range is wider than the guaranteed operating temperature range of lasers is not taken into consideration.

That is, when the temperature increases or decreases, an optical component, which couples laser beams of the three colors into a combined beam that travels along a single axis, would be displaced or deformed due to a deformation of a case that occurs due to a temperature difference between each portion. Thus, a deviation of the optical axis of the laser beam of each color, that is, a relative positional displacement of each spot on a display region such as a screen would be generated.

Patent Document 2 merely describes a temperature control method, and fails to disclose or suggest the problem of deviations of optical axes that occur due to a temperature difference between each portion generated when the temperature increases or decreases.

It is an object of the present invention to provide a compact optical module with heating and cooling devices for setting the temperatures of lasers to be within the guaranteed operating temperature range of the lasers, which can suppress a relative positional displacement of each spot on a display region such as a screen, and a scanning image display device.

In order to solve the aforementioned problems, configurations described in the appended claims are adopted, for example.

The present application includes a plurality of means for solving the aforementioned problems. For example, there is provided an optical module including a plurality of lasers mounted thereon, and configured to emit light beams from the plurality of lasers, the optical module including: a case on which the optical module is mounted, the plurality of lasers being connected to the case via a plurality of laser holders, respectively; a cooling device configured to cool the entire optical module via the case; and a plurality of heating devices provided on the respective laser holders and configured to individually heat the respective lasers.

There is also provided an optical module that includes, for example: a plurality of lasers including first to third lasers; a case on which the optical module is mounted, the second laser and the third laser being arranged on a plane of the case adjacent to a plane on which the first laser is arranged; a heat spreader connected to the case of the optical module, the heat spreader being extended on a horizontal plane in a direction of the second laser and the third laser away from the case when seen from the case; a cooling device arranged on an extended portion of the heat spreader; and a plurality of heating devices provided on a plurality of laser holders, respectively, and configured to individually heat the respective lasers.

There is also provided an optical module that includes, for example: a plurality of lasers including first to third lasers; a case on which the optical module is mounted, the second laser and the third laser being arranged on a plane of the case adjacent to a plane on which the first laser is arranged, the second laser being located close to the first laser, the third laser being located away from the first laser; a heat spreader connected to the case of the optical module, the heat spreader being extended in a direction of the first laser and the second laser when seen from the case; a cooling device arranged on an extended portion of the spreader; and a plurality of heating devices provided on a plurality of laser holders, respectively, and configured to individually heat the respective lasers.

Preferably, a substrate for supplying a current to the optical module may be arranged on a side opposite to a plane from which the laser beams are projected.

Preferably, a substrate for supplying a current to the optical module may be arranged on a side opposite to a plane from which the laser beams are projected, a green laser may be arranged as the third laser at a position farthest from the substrate, a blue laser may be arranged as the second laser, and a red laser may be arranged as the first laser at a position closest to the substrate.

Preferably, in the optical module including a case on which the optical module is mounted, the second laser and the third laser being arranged on a plane of the case adjacent to a plane on which the first laser is arranged; a heat spreader connected to the case of the optical module, the heat spreader being extended on a horizontal plane in a direction of the second laser and the third laser away from the case when seen from the case; a cooling device arranged on an extended portion of the heat spreader; and a plurality of heating devices provided on a plurality of laser holders, respectively, and configured to individually heat the respective lasers, a green laser may be arranged as the third laser, a red laser may be arranged as the second laser, and a blue laser may be arranged as the first laser.

Preferably, in the optical module including a case on which the optical module is mounted, the second laser and the third laser being arranged on a plane of the case adjacent to a plane on which the first laser is arranged, the second laser being located closes to the first laser, the third laser being located away from the first laser; a heat spreader connected to the case of the optical module, the heat spreader being extended in a direction of the first laser and the second laser when seen from the case; a cooling device arranged on an extended portion of the heat spreader; and a plurality of heating devices provided on a plurality of laser holders, respectively, and configured to individually heat the respective lasers, a green laser may be arranged as the first laser, a red laser may be arranged as the second laser, and a blue laser may be arranged as the third laser.

Preferably, a hole may be provided in each laser holder that accommodates each laser, and each heating device is attached to an inside of the laser holder via the hole.

Preferably, each heating device may be a coil wound around each laser holder that accommodates each laser.

Preferably, there is provided a scanning image display device including the optical module, in which an image is displayed by controlling light emission of the lasers.

The present invention can provide a compact optical module with heating and cooling devices for setting the temperatures of lasers to be within the guaranteed operating temperatures of the lasers, which can suppress relative positional displacements of spots on a display region such as a screen, and a scanning image display device.

In addition, for example, the present invention can, with regard to an optical module for a case where the ambient temperature range is wider than the guaranteed operating temperature range of the lasers, such as a head-up display mounted on a vehicle or the like, and a scanning image display device having such an optical module, provide a scanning image display device having an optical module with heating and cooling devices that can adjust the temperatures of lasers to be within the guaranteed operating temperature range of the lasers, so that relative positional displacements of laser spots of the plurality of lasers on a display region such as a screen can be suppressed.

Other objects, configurations, and advantages will become apparent from the following description of embodiments.

### BRIEF DESCRIPTION OF THE DRAWINGS

FIG. 1 is an overall configuration diagram of a scanning image display device in accordance with an embodiment of the present invention;

FIG. 2 is a perspective view showing a first embodiment of an optical module in accordance with the present invention;

FIG. 3 is a perspective view showing an embodiment of a heating element used in the present invention;

FIG. 4 is a perspective view showing an embodiment of a heating element used in the present invention;

FIG. 5 is a perspective view showing an embodiment of a heating element used in the present invention;

FIG. 6 is a perspective view showing a second embodiment of an optical module in accordance with the present invention; and

FIG. 7 is a perspective view showing a third embodiment of an optical module in accordance with the present invention.

### DETAILED DESCRIPTION

Hereinafter, embodiments of the present invention will be described with reference to the accompanying drawings. It should be noted that structures denoted by identical reference numerals have identical functions. Thus, if a structure denoted by a given reference numeral has been described previously, repeated description of such a structure may be omitted.

### Embodiment 1

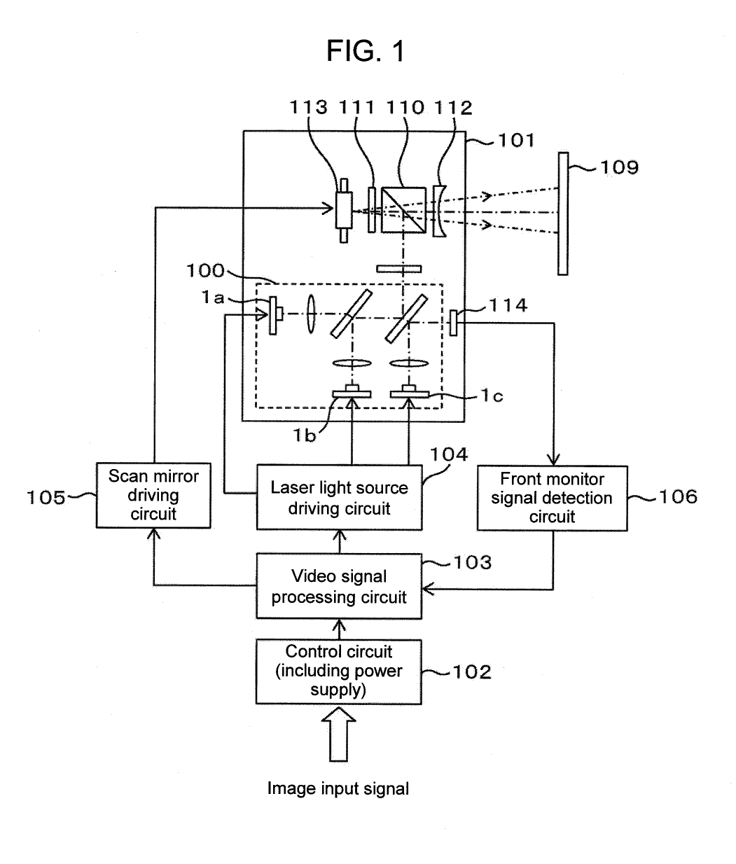

FIG. 1 is a configuration diagram of a scanning image display device in accordance with an embodiment of the present invention. In FIG. 1, an optical module 101 includes a laser light source module 100 having a first laser 1a, a second laser 1b, and a third laser 1c, which are laser light sources corresponding to the three colors of read (R), green (G), and blue (B), respectively, and a beam coupling unit that couples together light beams emitted from the respective laser light sources; a projection unit that projects the coupled light beam onto a screen 109; and a scan unit that allows a projection light beam to be two-dimensionally scanned on the screen 109. The projection unit includes a polarizing beam splitter (PBS) 110, a quarter-wave plate 111, an angle-of-view widening element 112, and the like. In addition, the scan unit includes a scan mirror 113 and the like.

An image signal to be displayed is input to a video signal processing circuit 103 via a control circuit 102 including a power supply and the like. The video signal processing circuit 103 performs various types of processing on the image signal, separates the image signal into signals of the three colors of R, G, and B, and transmits the signals to a laser light source driving circuit 104. The laser light source driving circuit 104 supplies a driving current for light emission to the corresponding lasers in the laser light source module 100 in accordance with the respective luminance values of the R, and B signals. Consequently, the lasers emit light beams with intensities corresponding to the respective luminance values of the R, G, and B signals in accordance with the display timing.

In addition, the video signal processing circuit 103 extracts a synchronization signal from the image signal and transmits the extracted signal to a scan mirror driving circuit 105. The scan mirror driving circuit 105 supplies a driving signal for two-dimensionally and repeatedly rotating a mirror surface to the scan mirror 113 in the optical module 101 in accordance with a horizontal/vertical synchronization signal. Accordingly, the scan mirror 113 periodically performs repeated rotation of the mirror surface by a predetermined angle to reflect a light beam, so that the light beam is scanned on the screen 109 in the horizontal direction and the vertical direction and an image is displayed on the screen 109.

A front monitor signal detection circuit 106 receives a signal from a front monitor 114, and detects the output levels of R, G, and B output from the respective lasers. The detected output levels are input to the video signal processing circuit 103 so that the laser outputs are controlled to attain predetermined outputs.

For the scan mirror 113, a biaxial driving mirror created using a MEMS (Micro electromechanical Systems) technology can be used, for example. As a driving method, piezoelectric drive, electrostatic drive, electromagnetic drive, and the like can be used. It is also possible to prepare and arrange two uniaxial scan mirrors so that light beam scanning can be performed in directions that are orthogonal to each other.

By the way, it is considered that the ambient temperature of a head-up display mounted on a vehicle or the like changes from −several ten ° C. to about +100° C. when left in a cold region or left in a hot summer day. Therefore, as a condition in which the ambient temperature range is wider than the guaranteed operating temperature range of lasers is present, heating or cooling for adjusting the temperatures of the lasers to be within the guaranteed operating range of the lasers should be performed in an optical module and a scanning image display device having such an optical module. Meanwhile, when the temperature of a laser is outside the guaranteed operating range of the laser, a difference in the visibility of each color would occur due to a temperature-dependent laser wavelength fluctuation, so that a color deviation of the image would occur such that the entire screen becomes reddish, or the laser output would decrease or the operating life of the laser would shorten.

In this case, there is a problem in that due to a temperature difference between each portion generated when the temperature increases or decreases, deviations of the optical axes would occur. When the optical axes of the light beams deviate, the spot positions on a display region such as a screen would be displaced. When the positional displacements of the spots of the three lasers differ from one another, the spot positions cannot coincide with one another, so that a resulting image becomes blurred.

Thus, in an embodiment of the present invention, the optical module 101 is configured so that the amount of relative positional displacements of spots of a plurality of lasers can be reduced by taking into consideration the arrangement of heating and cooling devices and components by which generation of deviations of the optical axes due to a temperature difference between each portion is suppressed.

An optical module is assembled and adjusted at a given reference temperature. Therefore, when a temperature difference is generated between each portion, deformation would be generated due to a difference in coefficients of thermal expansion between the components, so that the optical component(s) would be displaced or deformed, and thus deviations of the optical axes would be generated. In order to suppress such a phenomenon, heating and cooling structures without generation of a temperature difference between each portion are needed.

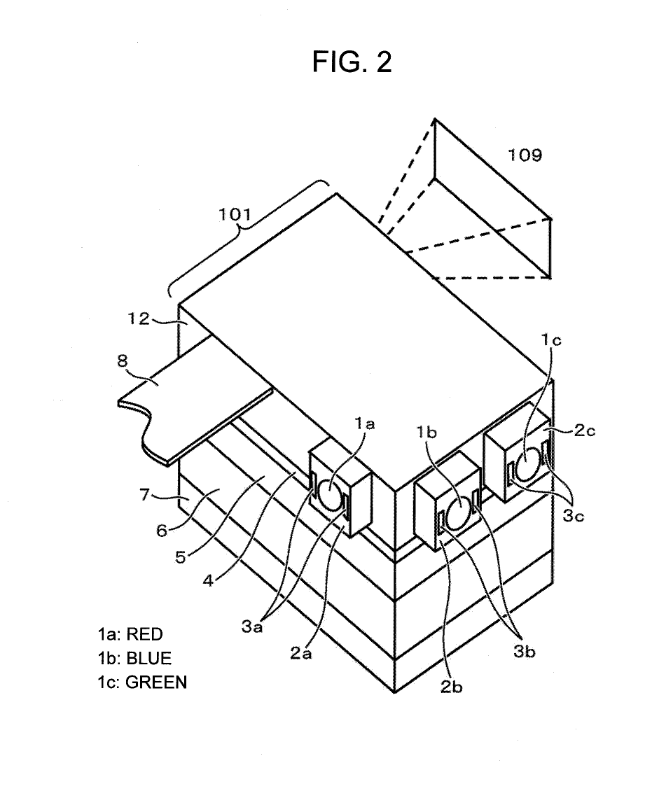

Hereinafter, the optical module 101 in accordance with an embodiment of the present invention will be described in further detail. FIG. 2 is a perspective view showing a first embodiment of the optical module in accordance with this embodiment.

In FIG. 2, the optical module 101 includes the first laser 1a, the second laser 1b, and the third laser 1c, and the lasers are attached to a first laser holder 2a, a second laser holder 2b, and a third laser holder 2c, respectively, for improving the handling. A first heating element 3a for local heating is attached to the first laser holder 2a. A second heating element 3b for local heating is attached to the second laser holder 2b. A third heating element 3c for local heating is attached to the third laser holder 2c. Each of the first laser holder 2a, the second laser holder 2b, and the third laser holder 2c is attached to a case 12 of the optical module 101 via an adhesive, a screw, a spring, or the like. The first heating element 3a, the second heating element 3b, and the third heating element 3c function as heating devices for the plurality of lasers including the first laser 1a, the second laser 1b, and the third laser 1c, respectively.

As a cooling device, a cooling element 5 is attached to the entire lower surface or upper surface of the case 12 with interposed therebetween thermally-conducive grease 4, a thermally conductive sheet, or a thermally conductive gel, and a heat dissipation fin 6 for the cooling element is attached to the other surface (the lower surface) to cool the entire optical module 101. In order to increase the efficiency of the heat dissipation fin 6, a fan 7 may be additionally arranged. Although the cooling device is provided at the bottom of the optical module 101 in FIG. 2, it may be provided at the top of the optical module 101.

By cooling the entire optical module 101, it becomes possible to reduce a temperature difference in the optical module 101, suppress a displacement or a deformation generated due to a difference in coefficients of thermal expansion among the components mounted on the optical module 101, and thus suppress positional displacements of spots of the plurality of lasers including the first laser 1a, the second laser 1b, and the third laser 1c, whereby the amount of relative positional displacements can be reduced.

Meanwhile, when the first laser 1a, the second laser 1b, and the third laser 1c are heated, the cooling element 5 and the heat dissipation fin 6 are not needed, so that a reduction in size of the heating device is possible. Therefore, the first heating element 3a for local heating is directly attached to the first laser holder 2a to locally heat the first laser 1a. In addition, the second heating element 3b for local heating is directly attached to the second laser holder 2b to locally heat the second laser 1b. Further, the third heating element 3c for local heating is directly attached to the third laser holder 2c to locally heat the third laser 1c. Accordingly, the temperatures of the laser portions can be within the guaranteed operating temperature range of the lasers, while the temperatures of the other portions in the optical module 101 can be at the ambient temperature, and the temperature difference in the optical module 101 can be minimized. Thus, by suppressing a displacement or a deformation generated due to a difference in coefficients of thermal expansion among the components mounted on the optical module 101 and thus suppressing positional displacements of spots of the plurality of lasers, it becomes possible to suppress the amount of relative positional displacements.

In this case, as the first heating element 3a has only to heat the first laser 1a and the first laser holder 2a, the heat capacity can be suppressed and a temperature rise time can be reduced. In addition, as the second heating element 3b has only to heat the second laser 1b and the second laser holder 2b, the heat capacity can be suppressed and a temperature rise time can be reduced. Further, as the third heating element 3c has only to heat the third laser 1c and the third laser holder 2c, the heat capacity can be suppressed and a temperature rise time can be reduced.

Besides, a substrate 8 (e.g., a flexible substrate) for supplying a current to the first laser 1a, the second laser 1b, and the third laser 1c serves as a member for conducting heat from the control unit 102, the video signal processing circuit 103, the laser light source driving circuit 104, and the like. Thus, the substrate 8 is arranged on a plane opposite to a side where a laser beam from the optical module 101 is projected onto the screen 109, at a position away from the first laser 1a, the second laser 1b, and the third laser 1c of the optical module 101. By dispersing a heat flux from the substrate 8 and heat generation of the first laser 1a, the second laser 1b, and the third laser 1c to thereby make the temperature distribution of the optical module 101 uniform, it becomes possible to suppress a displacement or a deformation generated due to a difference in coefficients of thermal expansion among the components mounted on the optical module 101 and thus suppress positional displacements of spots of the plurality of lasers. Thus, the amount of relative positional displacements can be suppressed, and efficient cooling throughout the entire device becomes possible.

Among the first laser 1a, the second laser 1b, and the third laser 1c mounted on the optical module 101, the power consumption of a green laser is the highest, that of a red laser is the second highest, and that of a blue laser is the third highest according to the properties of the lasers. Thus, with respect to the amount of heat generation of each laser that is not converted into a laser beam but becomes heat, the amount of heat generation of the green laser is the largest, that of the red laser is the second largest, and that of the blue laser is the third largest. That is, by arranging, as the arrangement of the lasers in the optical module 101, a green laser as the third laser 1c, which is at a position farthest from the substrate 8 that supplies a current to the lasers, arranging a blue laser as the second laser 1b, which is interposed between the two other lasers and thus is the least advantageous in heat dissipation, and arranging a red laser as the first laser 1b, it becomes possible to make the temperature distribution of the optical module 101 more uniform. According to such a component arrangement, it is possible to suppress a displacement or a deformation generated due to a difference in coefficients of thermal expansion among the components mounted on the optical module 101 and thus suppress positional displacements of spots of the plurality of lasers, whereby the amount of relative positional displacements can be suppressed, and efficient cooling is possible throughout the entire optical module.

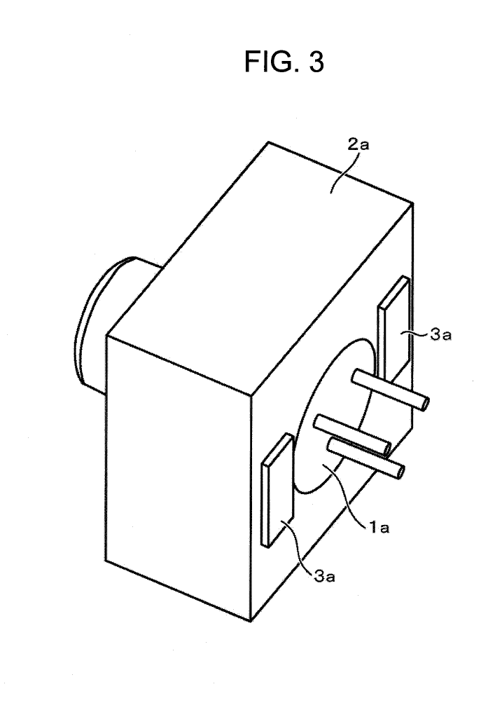

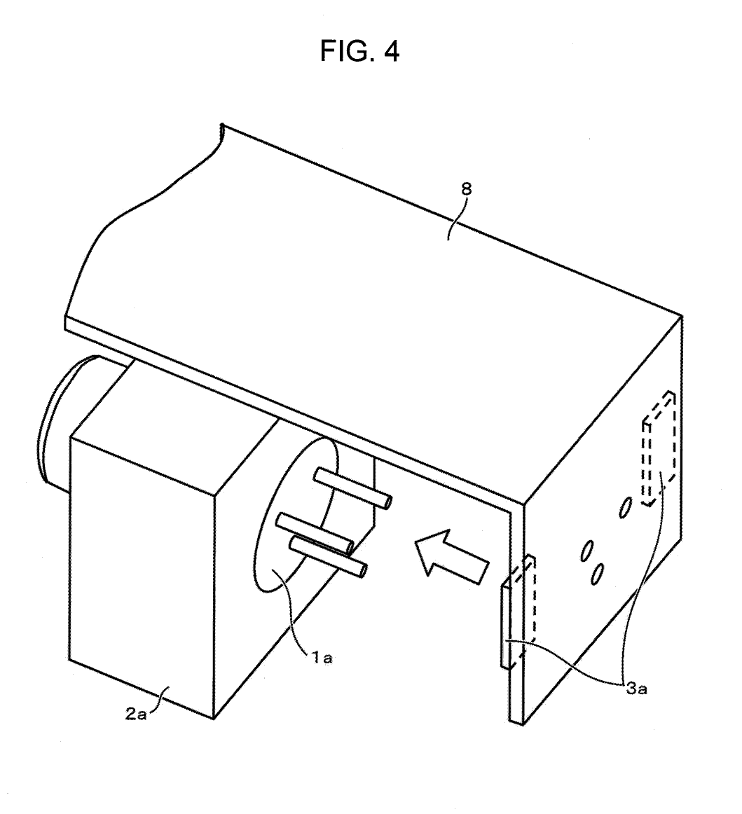

FIGS. 3, 4, and 5 are perspective views each showing an embodiment of a heating element used in the present invention. In FIG. 3, the first laser 1a is accommodated in the first laser holder 2a for facilitating and improving the handling of the laser. The first heating element 3a for local heating is attached to the first laser holder 2a. In this case, it is possible to stick the first heating element 3a to the first laser holder 2a, or provide a hole in the first laser holder 2a and embed the first heating element 3a therein. Alternatively, as shown in FIG. 4, it is also possible to arrange the first heating element 3a on the substrate 8 (e.g., a flexible substrate) for supplying a current to the first laser 1a, and install the substrate 8 so that the first heating element 3a comes into contact with the first laser holder 2a.

FIG. 4 shows a view in which the substrate 8 and the first laser 1a are apart from each other. However, it is assumed that the substrate 8 is relatively moved in a direction indicated by the arrow so that electrodes of the first laser 1a are inserted through holes in the substrate 8 and then are soldered. In FIGS. 3 and 4, a plurality of resistors including chip resistors may also be arranged as the first heating element 3a. Accordingly, a reduction in size and cost of the first heating element 3a can be achieved. In addition, when a plurality of first heating elements 3a are arranged, it becomes possible to heat the first laser 1a more uniformly than when a single first heating element 3a is arranged.

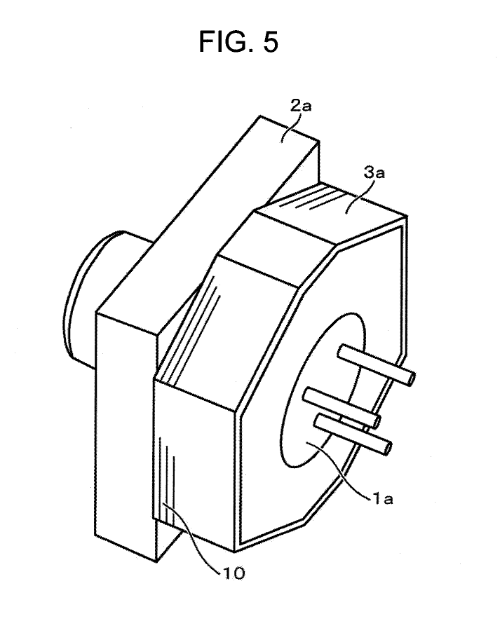

In FIG. 5, as the first heating element 3a, a coil 10 is wound around a part (which corresponds to an octagonal portion in FIG. 5) of the first laser holder 2a, and a current is flowed therethrough so that heat is generated. Thus, the first laser 1a can be uniformly heated via the first laser holder 2a, and the first heating element 3a that is compact and is low in cost can be provided.

Although FIGS. 3 to 5 each illustrate a heating configuration for the first laser 1a, a similar heating configuration may also be used for the second laser 1b and the third laser 1c.

In addition, when some lasers do not need heating because of the laser properties, a local heating element may be provided only for a laser that needs heating. Accordingly, the number of components can be reduced and a cost reduction can be achieved.

### Embodiment 2

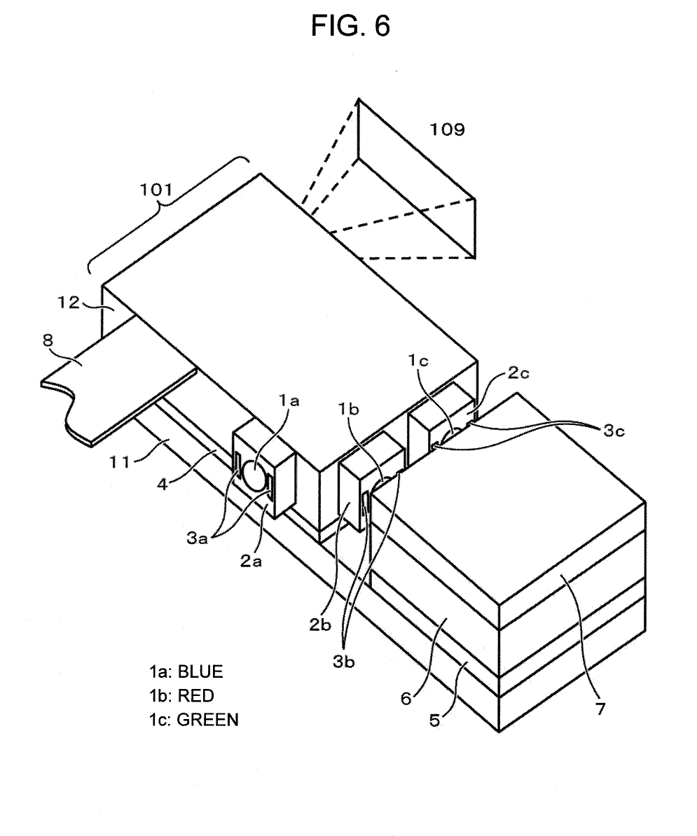

FIG. 6 is a perspective view showing a second embodiment of the optical module in accordance with this embodiment. In FIG. 6, a heat spreader 11 is arranged on the lower surface or the upper surface of the optical module 101 with interposed therebetween thermally-conducive grease 4, a thermally conductive sheet, or a thermally conductive gel. Then, the heat spreader 11 is extended on a horizontal plane in the direction of the second laser 1b and the third laser 1c away from the case 12 when seen from the case 12 so that the heat spreader 11 is connected to a cooling element 5 arranged next to the second laser 1b and the third laser 1c of the optical module 101, whereby the optical module 101 can be cooled. When such an arrangement is used, the cooling element 5 and a heat dissipation fin 6 and a fan 7 for the cooling element can be arranged in the height direction of the optical module 101. Thus, a reduction in thickness of the device is possible.

The first heating element 3a, the second heating element 3b, and the third heating element 3c are arranged corresponding to the first laser holder 2a, the second laser holder 2b, and the third laser holder 2c, respectively, as described previously.

Herein, as described above, a substrate 8 (e.g., a flexible substrate) for supplying a current to the first laser 1a, the second laser 1b, and the third laser 1c also serves as a member for conducting heat from the control circuit 102, the video signal processing circuit 103, the laser light source driving circuit 104, and the like. Thus, the substrate 8 is arranged on a plane opposite to a side where a laser beam from the optical module 101 is projected onto the screen 109, at a position away from the first laser 1a, the second laser 1b, and the third laser 1c of the optical module 101. Accordingly, a heat flux from the substrate 8 and heat generation of the first laser 1a, the second laser 1b, and the third laser 1c are dispersed, and thus the temperature distribution of the optical module 101 is made uniform. Accordingly, by suppressing a displacement or a deformation generated due to a difference in coefficients of thermal expansion among the components mounted on the optical module 101 and thus suppressing positional displacements of spots of the plurality of lasers, it becomes possible to suppress the amount of relative positional displacements, and perform efficient cooling throughout the entire device.

Among the lasers mounted on the optical module 101, the power consumption of a green laser is the highest, that of a red laser is the second highest, and that of a blue laser is the third highest according to the properties of the lasers. Thus, with respect to the amount of heat generation of each laser that is not converted into a laser beam but becomes heat, the amount of heat generation of the green laser is the largest, that of the red laser is the second largest, and that of the blue laser is the third largest. That is, by arranging, as the arrangement of the lasers in the optical module 101, a green laser as the third laser 1c, which is at a position farthest from the substrate 8 that supplies a current to the laser and closest to the cooling element 5, arranging a red laser as the second laser 1b at a position next closest to the cooling element 5, and arranging a blue laser as the first laser 1a, it becomes possible to make the temperature distribution of the optical module 101 more uniform. According to such a component arrangement, it is possible to suppress a displacement or a deformation generated due to a difference in coefficients of thermal expansion among the components mounted on the optical module 101 and thus suppress positional displacements of spots of the plurality of lasers, whereby the amount of relative positional displacements can be suppressed, and efficient cooling is possible throughout the entire device.

### Embodiment 3

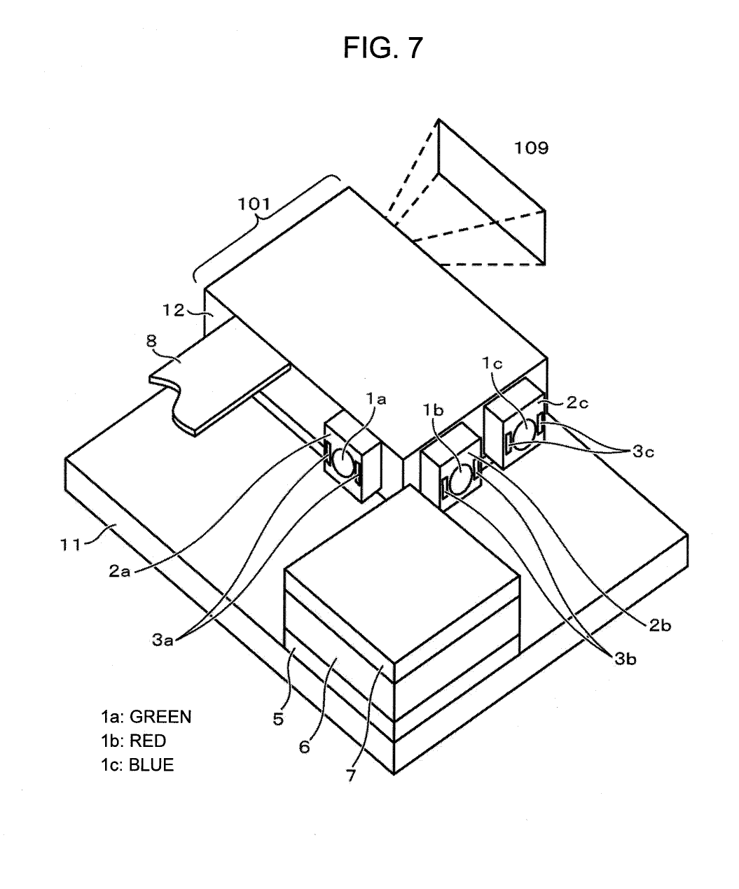

FIG. 7 is a perspective view showing a third embodiment of the optical module in accordance with this embodiment. In FIG. 7, as the arrangement of optical components, when a green laser is arranged as the first laser 1a, a red laser is arranged as the second laser 1b, and a blue laser is arranged as the third laser 1c for convenience of the optical properties, a heat spreader 11 is arranged on the lower surface or the upper surface of the optical module 101 as in the second embodiment, and the heat spreader 11 is extended in a horizontal plane in the direction of the first laser 1a and the second laser 1b away from the case 12 when seen from the case 12 so that the heat spreader 11 is connected to a cooling element 5 arranged next to and interposed between the first laser 1a and the second laser 1b of the optical module 101, whereby the temperature distribution of the optical module 101 can be made uniform. According to such a component arrangement, it is possible to suppress a displacement or a deformation generated due to a difference in coefficients of thermal expansion among the components mounted on the optical module 101 and thus suppress positional displacements of spots of the plurality of lasers, whereby the amount of relative positional displacements can be suppressed, and efficient cooling is possible throughout the entire device.

When a Peltier element is used as the cooling element 5, it is possible to, by utilizing the characteristics of the Peltier element that can perform heating and cooling with the electrodes reversed, use the Peltier element as a fourth heating element by reversing the electrodes of the Peltier element at the same time as the first heating element 3a, the second heating element 3b, and the third heating element 3c. When the first heating element 3a, the second heating element 3b, the third heating element 3c, and the fourth heating element are driven at the same time, it becomes possible to shorten the time for increasing the temperatures of the first laser 1a, the second laser 1b, and the third laser 1c within the guaranteed operating temperature range of the lasers.

In order to perform full color display, three light sources are typically used. However, depending on applications, using two light sources or using four or more light sources by adding an auxiliary light source(s) is also considered. Even in such cases, it is possible to reduce relative displacements of spots by applying the configuration of the present invention.

As described above, according to the present invention, in an optical module that aligns light beams from lasers of the three colors of red, green, and blue along a single combined beam optical axis, specifically, in the optical module for a case where the ambient temperature range is wider than the guaranteed operating temperature range of the lasers, such as a head-up display mounted on a vehicle or the like, and a scanning image display device having such an optical module, if heating and cooling devices are used that adjust the temperatures of the lasers to be within the guaranteed operating temperature range of the lasers, it becomes possible to reduce relative positional displacements of beam spots of the three colors (three points or spots created by light beams from the laser light sources of the three colors on a projection target plane).

As described above, in an optical module that aligns light beams from lasers of the three colors of red, green, and blue along a single combined beam optical axis, for a case where the ambient temperature range is wider than the guaranteed operating temperature range of the lasers, for example, the above embodiments can reduce relative positional displacements of beam spots of the three colors generated due to a displacement or a deformation resulting from a temperature change at a heating or cooling time. According to the embodiments, it is possible to provide a compact optical module that can reduce relative positional displacements of spots on a display region such as a screen by having a cooling device that cools the entire optical module via a case on which the optical module is mounted and having on each laser holder a heating device that individually heats each laser, and a scanning image display device having such an optical module.

Further, with respect to an optical module for a case where the ambient temperature range is wider than the guaranteed operating range of lasers, such as a head-up display mounted on a vehicle or the like, and a scanning image display device having such an optical module, it is possible to provide a scanning image display device having an optical module with heating and cooling devices that can adjust the temperatures of the lasers to be within the guaranteed operating temperature range of the lasers and that thus reduce relative positional displacements of laser spots of the plurality of lasers on a display region such as a screen.

The present invention is not limited to the aforementioned embodiments, and includes various variations. For example, although the aforementioned embodiments have been described in detail to clearly illustrate the present invention, the present invention need not include all of the structures described in the embodiments. It is possible to replace a part of a structure of an embodiment with a structure of another embodiment. In addition, it is also possible to add, to a structure of an embodiment, a structure of another embodiment. Furthermore, it is also possible to, for a part of a structure of each embodiment, add/remove/substitute a structure of another embodiment.

Some or all of the aforementioned structures, functions, processing units, processing means, and the like may be implemented by hardware through designing of an integrated circuit, for example. Alternatively, each of the aforementioned structures, functions, and the like may be implemented by software so that a processor analyzes and executes a program that implements each function. Information such as the program that implements each function, tables, and files can be placed on a recording medium such as memory, a hard disk, or a SSD (Solid State Drive); or a recording medium such as an IC card, an SD card, or a DVD.

In addition, the control lines and information lines represent those that are considered to be necessary for the description, and do not necessarily represent all control lines and information lines that are necessary for a product. In practice, almost all structures may be considered to be mutually connected.

### REFERENCE SIGNS LIST

1a: First laser
1b: Second laser
1c: Third laser
2a: First laser holder
2b: Second laser holder
2c: Third laser holder
3a: First heating element
3b: Second heating element
3c: Third heating element
4: Thermally conductive grease
5: Cooling element
6: Heat dissipation fin
7: Fan
8: Substrate
11: Heat spreader
12: Case
100: Laser light source module
101: Optical module
102: Control circuit
103: Video signal processing circuit
104: Laser light source driving circuit
105: Scan mirror driving circuit
106: Front monitor signal detection circuit
109: Screen
110: Polarizing beam splitter (PBS)
111: Quarter-wave plate
112: Angle-of-view widening element
113: Scan mirror
114: Front monitor

What is claimed is:

1. An optical module comprising a plurality of lasers mounted thereon, and configured to emit light beams from the plurality of lasers, the optical module further comprising:
a case on which the optical module is mounted, the plurality of lasers being connected to the case via a plurality of laser holders, respectively;
a cooling device configured to cool the entire optical module via the case; and
a plurality of heating devices provided on the respective laser holders and configured to individually heat the respective lasers.

2. An optical module comprising a plurality of lasers including first to third lasers mounted thereon, and configured to emit light beams from the plurality of lasers, the optical module further comprising:
a case on which the optical module is mounted, the second laser and the third laser being arranged on a plane of the case adjacent to a plane on which the first laser is arranged;
a heat spreader connected to the case of the optical module, the heat spreader being extended on a horizontal plane in a direction of the second laser and the third laser away from the case when seen from the case;
a cooling device arranged on an extended portion of the heat spreader; and
a plurality of heating devices provided on a plurality of laser holders, respectively, and configured to individually heat the respective lasers.

3. An optical module comprising a plurality of lasers including first to third lasers mounted thereon, and configured to emit light beams from the plurality of lasers, the optical module further comprising:
a case on which the optical module is mounted, the second laser and the third laser being arranged on a plane of the case adjacent to a plane on which the first laser is arranged, wherein the second laser is located close to the first laser and the third laser is located away from the first laser;
a heat spreader connected to the case of the optical module, the heat spreader being extended in a direction of the first laser and the second laser when seen from the case;
a cooling device arranged on an extended portion of the heat spreader; and
a plurality of heating devices provided on a plurality of laser holders, respectively, and configured to individually heat the respective lasers.

4. The optical module according to claim 1, further comprising a substrate for supplying a current to the optical module, the substrate being arranged on a side opposite to a plane from which the laser beams are projected.

5. The optical module according to claim 1, further comprising a substrate for supplying a current to the optical module, the substrate being arranged on a side opposite to a plane from which the laser beams are projected, wherein
the plurality of lasers comprises a first laser, a second laser, and a third laser,
a green laser is arranged as the third laser at a position farthest from the substrate,
a blue laser is arranged as the second laser, and
a red laser is arranged as the first laser at a position closest to the substrate.

6. The optical module according to claim 2, wherein a green laser is arranged as the third laser, a red laser is arranged as the second laser, and a blue laser is arranged as the first laser.

7. The optical module according to claim 3, wherein a green laser is arranged as the first laser, a red laser is arranged as the second laser, and a blue laser is arranged as the third laser.

8. The optical module according to claim 1, wherein a hole is provided in each laser holder that accommodates each laser, and each heating device is attached to an inside of the laser holder via the hole.

9. The optical module according to claim 1, wherein each heating device is a coil wound around each laser holder that accommodates each laser.

10. A scanning image display device comprising the optical module according to claim 1, wherein an image is displayed by controlling light emission of the lasers.

11. The optical module according to claim 2, further comprising a substrate for supplying a current to the optical module, the substrate being arranged on a side opposite to a plane from which the laser beams are projected.

12. The optical module according to claim 3, further comprising a substrate for supplying a current to the optical module, the substrate being arranged on a side opposite to a plane from which the laser beams are projected.

13. The optical module according to claim 2, wherein a hole is provided in each laser holder that accommodates each laser, and each heating device is attached to an inside of the laser holder via the hole.

14. The optical module according to claim 3, wherein a hole is provided in each laser holder that accommodates each laser, and each heating device is attached to an inside of the laser holder via the hole.

15. The optical module according to claim 2, wherein each heating device is a coil wound around each laser holder that accommodates each laser.

16. The optical module according to claim 3, wherein each heating device is a coil wound around each laser holder that accommodates each laser.

17. A scanning image display device comprising the optical module according to claim 2, wherein an image is displayed by controlling light emission of the lasers.

18. A scanning image display device comprising the optical module according to claim 3, wherein an image is displayed by controlling light emission of the lasers.

19. A scanning image display device comprising the optical module according to claim 4, wherein an image is displayed by controlling light emission of the lasers.

20. A scanning image display device comprising the optical module according to claim 5, wherein an image is displayed by controlling light emission of the lasers.
